(19) United States
(12) Patent Application Publication
(10) Pub. No.: US 2004/0088715 A1
(43) Pub. Date: May 6, 2004

(54) Interactive notification system and method

(75) Inventors: Toby Korall, Herzlya (IL); Eyal Levy, Raanana (IL); Aviram Bogin, Wakefield, MA (US)

Correspondence Address: SUGHRUE MION, PLLC, 2100 PENNSYLVANIA AVENUE, N.W., SUITE 800, WASHINGTON, DC, 20037, US

(73) Assignee: COMVERSE, LTD.

(21) Appl. No.: 10/284,235

(22) Filed: Oct. 31, 2002

(51) Int. Cl. G06F 15/16

(52) U.S. Cl. 719/318

(57) ABSTRACT

An interactive multimedia, two-way notification system and method transforms a notification message into a dynamic marketing channel. When a notification message is triggered, an external application provides promotional text that is personalized to the intended recipient of the notification message. The promotional text is added to the notification message, which is then forwarded to the recipient. If the recipient replies to the notification message, an interactive two-way messaging session is established between the recipient and the external application.

### BACKGROUND OF THE INVENTION

1. Field of the Invention

The present invention relates to a notification system and method, and in particular to an interactive multimedia, two-way notification system and method.

2. Background and Related Art

A conventional approach to alerting a subscriber that a voice mail message has been stored in the subscriber's voice mail box is by the voice mail system sending a Short Message Service (SMS) message notifying the subscriber. The concept of sending voice mail notification messages to a subscriber has been extended to include other services. For example, receipt of a facsimile or e-mail message could trigger a notification message.

SMS provides the ability to send and receive text messages to and from mobile telephones and other devices. SMS was originally created as part of the Global System for Mobile Communication (GSM). Indeed, developers initially viewed SMS as a tool for voice mail notification, although other uses, such as person-to-person messaging, have arisen.

Mobile Originated—Mobile Terminated (MO-MT) services involve an SMS message sent from one subscriber to another subscriber or to an application. For example, Mobile Originated messages include SMS messages sent from a subscriber's mobile phone to another mobile phone, an e-mail address, or the Internet. Likewise, Mobile Terminated messages include SMS messages received by a subscriber's mobile phone from another mobile phone, an e-mail account, or the Internet.

These MO-MT messages are sent/received in a proactive manner by the subscribers, supporting interactive two-way communication. Thus, unlike a notification message, wherein the subscriber plays a passive role, MO-MT messages provide a mechanism wherein the subscriber can actively participate in the messaging, e.g., by sending a reply message.

However, as discussed below, there is an unmet need for a notification system that provides for the interactivity offered by an MO-MT session.

### SUMMARY OF THE INVENTION

It is therefore a feature of the present invention to realize an interactive notification system and method.

Another feature of the present invention is to expand notification messages to include additional information/content, for example, promotional information.

Yet another feature of the present invention is to provide additional content to a subscriber, wherein the additional content is personalized to the subscriber.

Still another feature of the present invention is to provide a user-friendly (menu-driven) interactive communication session triggered by a notification event.

The present invention improves upon conventional passive notification messages, by allowing additional information and content to be appended to a notification message. Through the use of subscriber profile information, this additional information can be personalized to a particular subscriber. For example, an advertisement tailored to the subscriber's interests could be appended to a notification message of the subscriber. Furthermore, the subscriber can respond to the expanded notification message by using a simple menu-driven interface. Based on the subscriber's response, an active two-way messaging session can be established between the subscriber and an application, so that additional related information and content can be provided to the subscriber. Thus, for example, the subscriber could respond to the aforementioned advertisement and receive additional information and content relating to the advertised product or service.

The present invention offers numerous advantages over conventional passive notification messages. For example, the present invention provides a non-intrusive vehicle for promoting services and content, allowing operators to append promotional text and multimedia content to notification messages. Because notification messages are generally welcomed by their recipients, the expanded notification messages are less likely to be viewed as intrusive, “spam”, etc. Thus, the present invention is a tool for increasing operator revenues and average revenue per user, while reducing the customer conversion rate (“churn”), through its non-intrusive promotion of services, as well as for encouraging usage of existing and new services.

Furthermore, the present invention allows the proffered services and content to be tailored to a subscriber's particular interests, language of choice, etc.

Even further, the present invention can be implemented without modifying the subscriber's hardware, e.g. mobile telephone, or the notification triggering hardware, e.g. voice mail system.

Further still, the interactive, menu-driven component of the present invention allows for subscribers to navigate easily through the interactive menus, choose a link, and connect to the desired service and/or receive the proffered content.

### BRIEF DESCRIPTION OF THE DRAWINGS

The above and further objects, features and advantages of the invention will become clear from the following more detailed description when read with reference to the accompanying drawings in which:

FIG. 1 is an illustrative example of a system according to one non-limiting embodiment of the present invention.

FIG. 2 is an illustrative example of a user interaction in response to a notification message.

FIG. 3 is an illustration of the general flow of operation for a method of the present invention.

### DETAILED DESCRIPTION OF THE PREFERRED EMBODIMENTS

In the following detailed description of the present invention, reference is made to the accompanying drawings, which form a part hereof and in which is shown, by way of illustration, embodiments in which the invention may be practiced. The following detailed description is, therefore, not to be taken in a limiting sense and the scope of the present invention is defined by the appended claims.

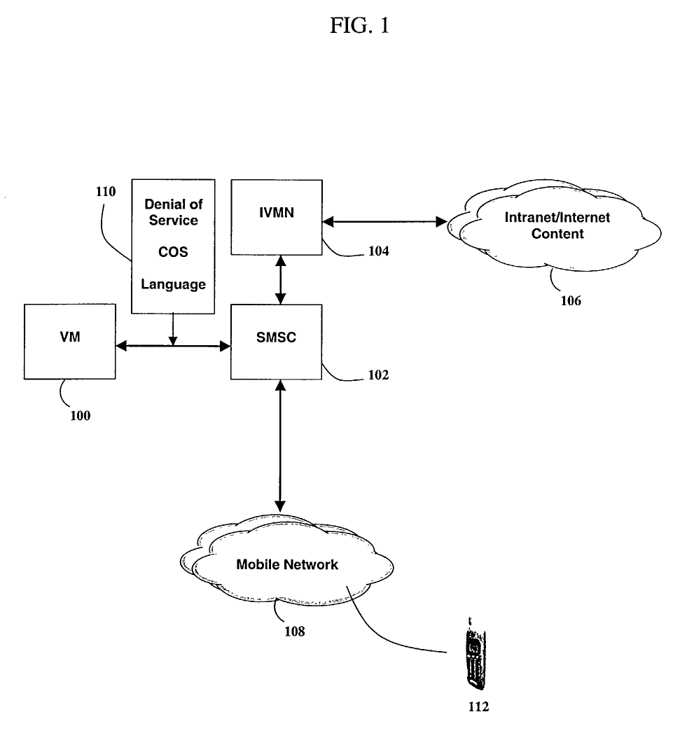

Depicted in FIG. 1 is an exemplary embodiment of the interactive notification system, in which a notification message is triggered by receipt of a voice mail message. A voice mail (VM) system 100 allows voice mail messages to be created and stored for later retrieval by a subscriber. Upon receipt of a new voice mail message, the VM system 100 generates a notification message. As a non-limiting example, the notification message is sent as an SMS message.

The notification message is then conveyed to a short message service center (SMSC) 102. The SMSC would normally store and forward the notification message to the subscriber's handset 112 using the mobile network 108. However, the present invention determines whether the intended recipient of the notification message is a subscriber to the interactive notification service.

Subscriber profile information 110 is used to determine whether the intended recipient of a notification message should instead receive an interactive notification message. Non-limiting examples of the subscriber profile information 110 include denial of service information, class of service information, and information on the subscriber's preferred language. The subscriber profile information 110 can be stored, for example, within the VM system 100, the SMSC 102, or a separate database accessible by the system components.

If the intended recipient is entitled to receive an interactive notification message, the SMSC does not forward the notification message to the subscriber's handset 112 using the mobile network 108. Instead, the SMSC forwards the notification message to an interactive voice mail notification (IVMN) application 104, wherein the IVMN application 104 obtains additional information personalized to the subscriber's interests. The subscriber profile information 110 may be used to obtain the additional information personalized to the subscriber's interests. For example, the subscriber profile information 110 can include information on the subscriber's age, gender, address, occupation, hobbies, interests, marital status, number of children, etc. that can be used to select and/or personalize the additional information.

The IVMN application 104 can be a stand-alone component or can be integrated with the SMSC 102, for example as a software program running in the SMSC 102. The IVMN application 104 receives the notification message and then searches for additional information and/or content personalized to the intended recipient of the notification message. The IVMN application 104 can search, for example, an intranet or the Internet 106 and/or some other storage or database (not shown) for this additional personalized information.

Upon obtaining the additional information and/or content, the IVMN application 104 converts the retrieved information, if necessary, into a format compatible with the original notification message. The IVMN application 104 then appends the additional information to the original notification message. This is feasible for SMS messages because a typical notification message requires only about 40 characters, while an SMS message can support up to 160 characters. Furthermore, the invention is applicable to any notification message having room for additional data or to which additional data can be attached. Likewise, the invention is applicable to other messaging systems as well, for example Wireless Application Protocol (WAP) messaging. Additionally, in a preferred embodiment, the additional information is inserted before the notification information in the notification message.

Thus, the IVMN application 104 combines the original notification message and the additional personalized information, such as an advertisement, into a single SMS message. The IVMN application 104 then sends the expanded notification message to the SMSC 102. The SMSC 102 stores and forwards the expanded notification message to the subscriber's handset 112 via the mobile network 108.

While the above illustrative embodiment was described in the context of receiving a voice mail message, other potential triggering events include a missed call, receipt of an e-mail message, and receipt of a fax.

Furthermore, in the above illustrative embodiment, notification messages are shown as reaching the subscriber's handset 112 through the mobile network 108. However, the present invention is also capable of sending notification messages through other communications networks, such as a wired network. Additionally, the notification message may be received by a subscriber device other than a mobile telephone handset, e.g. a personal digital assistant or a computer.

The appended information is configurable based on a subscriber's needs as well as interests. For example, the additional information retrieved by the IVMN application 104 can vary depending on the date and time, the subscriber's geographic location, etc.

The appended information can include embedded links to promotions, services, and other content, and wireless markup language (WML) extensions are supported. Furthermore, the appended information can include menu-driven prompts.

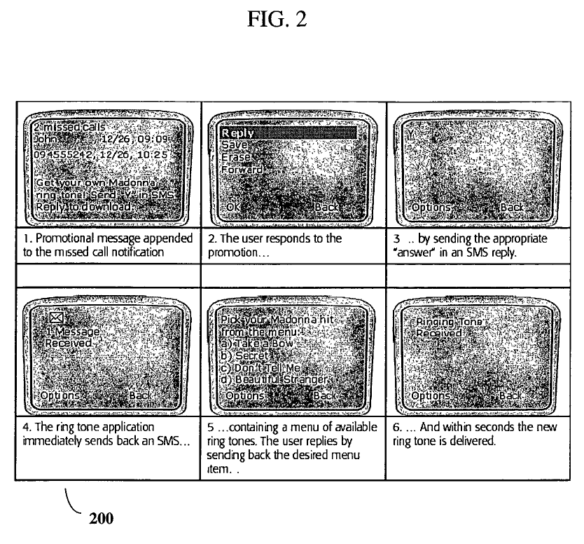

For example, as shown in FIG. 2, various screenshots 200 illustrate a subscriber's interaction with an interactive notification message. First, a notification message is generated to alert the subscriber that two calls were missed. This notification message has additional information appended to it in the form of an offer to receive a ring tone. This offer reflects the subscriber's personal interests, e.g. a Madonna fan, as determined from the subscriber's profile information. The appended message is then sent to the subscriber and displayed on the subscriber's handset, as shown in box 1, wherein the subscriber is prompted to send a “Y” in an SMS reply message in order to download the additional content, i.e. the ring tone. In box 2, the subscriber selects the “Reply” option from the menu displayed on the handset. In box 3, the subscriber inputs a “Y” in the reply SMS message. Upon receipt of the reply message, the ring tone application sends a reply SMS message, as shown in box 4, containing a menu of available Madonna ring tones, as shown in box 5. The subscriber sends a reply SMS message containing the desired menu selection. Upon receipt of the subscriber's SMS message, the ring tone application delivers the requested ring tone, as shown in box 6.

As described above, an interactive two-way messaging session can be established when the subscriber responds to an interactive notification message. Thus, an expanded notification message can ask a subscriber to send a particular response in order to access the proffered service or receive additional information and/or content. By replying to the expanded notification message, the subscriber initiates an interactive session with the pertinent service application. The interactive session can utilize “reply path” functionality so that the subscriber's response messages are automatically addressed to the proper recipient.

The IVMN application 104 manages the two-way exchange of SMS messages between the subscriber and the service application. For example, the IVMN application 104 keeps track of the subscriber's menu selections and performs any protocol/data conversion necessary to translate between the SMS text messages and the network-specific/application-specific requests. In the case of requesting additional information from the Internet, for example, the IVMN application 104 translates the SMS text messages to hypertext transfer protocol (HTTP) requests and vice versa.

The IVMN application 104 can ensure that the appended information is accurate and timely, e.g., by refreshing the appended information before every attempt at delivering the notification message. This is particularly useful for time-dependent offers.

The IVMN application 104 preferably also includes a session memory for storing the history of a session. The session history includes the SMS dialog conducted between the subscriber and the service provider. Thus, the session memory enables recovery of an interactive session after a system crash.

Additionally, the default duration of an interactive session is preferably configurable by the operator. Active sessions are managed by the IVMN application 104, which keeps track of the session history. As long as the subscriber continues to interact with the service, the session remains active. However, when the subscriber stops responding and there is no activity for a pre-configured time interval, the session will time-out and its history will be deleted from the session memory. Other non-limiting manners of terminating a session include successfully completing a transaction, as requested by the subscriber, and as required by a change in the subscriber's profile.

If a subscriber fails to respond to an interactive notification message before the expiration of the pre-configured time interval, the ability to initiate an interactive session by responding to the interactive notification message will have lapsed. However, in this case, the system can be configured to send the subscriber a restart notification message. For example, the system can be configured to send such a restart notification message based on the operator's rules, subscriber's preferences, etc. The restart notification message offers the subscriber an additional opportunity to initiate the interactive session that had previously lapsed.

The IVMN application 104 provides a user-friendly interface in the form of a textual browser menu operable on the subscriber's handset 112. The browser menu can be enhanced as a multimedia browser to support, for example, a touch screen and speech recognition. The browser menu of the IVMN application 104 provides simple navigation tools that help subscribers browse menus and go back one page or to a homepage.

Additionally, development tools can be distributed with the interactive notification system. For example, a web-based message composer makes it easy for operators to create interactive notification messages containing text and intranet/Internet links. The composer application/component includes a character counter to prevent the operator from exceeding the allowed message size. For example, once an operator has completed creating the message, the composer automatically generates the corresponding SMS message that can be appended to outgoing notification messages. Furthermore, the operator can test the functionality of the created message including, for example, how it appears displayed on a handset and how any embedded links function.

Thus, the operator can create and the system can store different messages to be appended to notification messages. These different messages are dispatched to particular subscribers based on the profile information 110 of the subscribers. Furthermore, the same message can be appended to different notification messages, whether the notification messages are intended for the same subscriber or different subscribers.

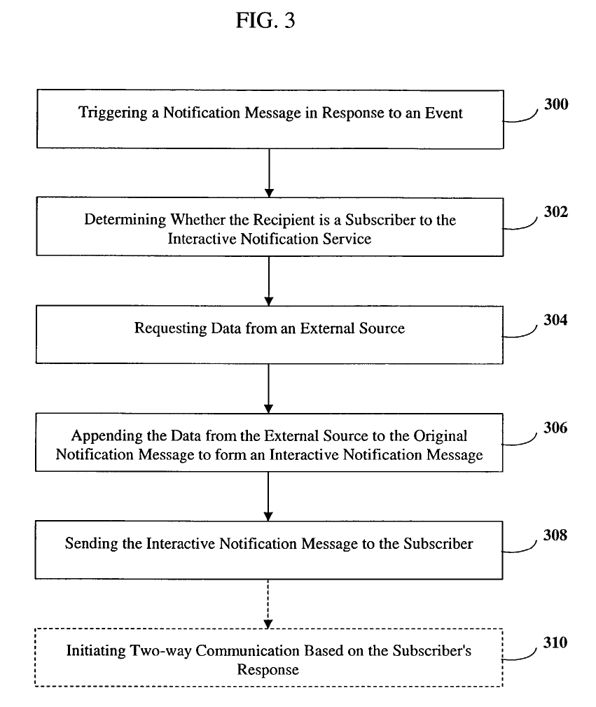

Depicted in FIG. 3 is a flowchart of an exemplary embodiment of the interactive notification method, in which a notification message is triggered in response to an event (300). As discussed above, example triggering events include a missed call or receipt of a voice mail message, an e-mail message, or a fax.

Next, a determination is made as to whether the intended recipient of the notification message is a subscriber to the interactive notification service (302). This determination is made by referencing the intended recipient's profile information, which includes, for example, class of service information, denial of service information, and subscriber preference information. An example of subscriber preference information is the subscriber's preferred language.

If it is determined that the recipient is not a subscriber to the interactive notification service and/or not allowed to receive interactive notification messages, then the notification message is simply routed to the subscriber. Otherwise, additional data is requested from an external source, such as an intranet, the Internet, or a database (304). This additional data can be personalized to the subscriber by using the subscriber's profile information.

Once retrieved, the additional data is appended to the original notification message forming an interactive notification message (306). Thereafter, the interactive notification message is sent to the subscriber (308).

The interactive notification message can invite the subscriber to respond to the message in order to access a service and/or receive additional data. If the subscriber sends a response requesting access to the service and/or transmission of additional data, a two-way messaging session is initiated between the subscriber and the external application/data source (310). The operation of 310 is indicated by dashed lines because a subscriber may elect to simply not respond to the interactive notification message.

The interactive notification method can be implemented, for example, by computer software and/or hardware operating independently of the SMSC (e.g., on a server) or integrated therewith.

Other modifications and variations to the invention will be apparent to those skilled and the art from the foregoing disclosure and teachings. Thus, while only certain illustrative embodiments of the invention have been specifically described herein, it will be apparent that numerous modifications may be made thereto without departing from the spirit and scope of the invention.

We claim:

1. A method for alerting a subscriber, comprising:
generating a notification message in response to an event;
retrieving additional data;
appending the additional data to the notification message; and
delivering the notification message including the additional data to the subscriber.

2. A method for alerting a subscriber, comprising:
generating a notification message in response to an event;
determining whether the subscriber should receive an interactive notification message;
when it is determined that the subscriber should receive an interactive notification message, retrieving additional data;
appending the additional data to the notification message to form the interactive notification message; and
delivering the interactive notification message to the subscriber.

3. The method of claim 2, further comprising accessing profile information for the subscriber.

4. The method of claim 3, wherein the profile information is used to determine whether the subscriber should receive an interactive notification message.

5. The method of claim 3, wherein the profile information is used to selectively retrieve the additional data, such that said additional data is personalized to the subscriber.

6. The method of claim 3, wherein the profile information includes one or more of a class of service information, a denial of service information, and a preferred language information.

7. The method of claim 1, wherein the event is at least one of missing a call, receiving a voice mail message, a receiving an e-mail message, and receiving a fax.

8. The method of claim 1, wherein the notification message is generated by at least one of a voice mail system, an e-mail system, a facsimile system, and a caller identification system.

9. The method of claim 1, wherein the notification message including the additional data is delivered to the subscriber via at least one of a wireless communications network and a wired communications network.

10. The method of claim 1, wherein the notification message including the additional data is delivered to at least one of a telephone handset, a personal digital assistant, and a computer, associated with the subscriber.

11. The method of claim 1, wherein the additional data is retrieved from at least one of a network, the Internet, and a database.

12. The method of claim 3, wherein the additional data is retrieved by performing a search using a search query, said search query being derived from the profile information.

13. The method of claim 1, further comprising converting the additional data to a compatible format before appending the additional data to the notification message.

14. The method of claim 1, wherein the additional data is inserted before pre-existing data of the notification message.

15. The method of claim 1, further comprising:
when the subscriber responds to the interactive notification message, delivering the reply message to a service application; and
initiating a two-way messaging session between the subscriber and the service application.

16. The method of claim 15, further comprising:
retrieving subsequent data via the two-way messaging session; and
delivering a message including the subsequent data to the subscriber.

17. The method of claim 15 further comprising terminating the two-way messaging session when a predetermined period of time expires without any activity by the subscriber or the service application.

18. The method of claim 1, further comprising:
displaying a menu of available options; and
responding to an interactive notification message by using the menu.

19. The method of claim 15, further comprising storing a history of the two-way messaging session.

20. The method of claim 16, further comprising refreshing the subsequent data prior to delivering the message including the subsequent data to the subscriber.

21. The method of claim 1, further comprising detecting the event to which the subscriber is to be alerted.

22. The method of claim 5, wherein the additional data is selectively retrieved based on at least one of a current date, a current time, and a geographic location of the subscriber.

23. A computer readable medium having software instructions for enabling a computer to perform predetermined operations, said operations comprising:
generating a notification message in response to an event;
retrieving additional data;
appending the additional data to the notification message; and
delivering the notification message including the additional data to the subscriber.

24. A computer readable medium having software instructions for enabling a computer to perform predetermined operations, said operations comprising:
generating a notification message in response to an event;
determining whether the subscriber should receive an interactive notification message;
when it is determined that the subscriber should receive an interactive notification message, retrieving additional data;
appending the additional data to the notification message to form the interactive notification message; and
delivering the interactive notification message to the subscriber.

25. The computer readable medium of claim 24, wherein the predetermined operations further comprise accessing profile information for the subscriber.

26. An interactive notification application, comprising software instructions for enabling a computer to perform predetermined operations, wherein the predetermined operations include:
intercepting a notification message;
retrieving additional data; and
appending the additional data to the notification message.

27. An interactive notification application, comprising software instructions for enabling a computer to perform predetermined operations, wherein the predetermined operations include:
intercepting a notification message in response to an event;
determining whether the subscriber should receive an interactive notification message;
when it is determined that the subscriber should receive an interactive notification message, retrieving additional data; and
appending the additional data to the notification message to form the interactive notification message.

28. A system for alerting a subscriber comprising:
a communications system, said communications system generating a notification message in response to a triggering event;
a message control system for routing messages; and
an interactive notification application,
wherein the interactive notification application retrieves additional data, said additional data being appended to the notification message to form an interactive notification message; and
wherein said message control system routes the interactive notification message to the subscriber.

29. The system of claim 28, further comprising a data store for storing profile information of the subscriber.

30. The system of claim 29, wherein the profile information is used by the interactive notification application to retrieve the additional data.

31. The system of claim 30, wherein the addition data is retrieved based on at least one of a current time, a current date, and a geographic location of the subscriber.

32. The system of claim 29, wherein the profile information is used to determine whether to retrieve the additional data.

33. The system of claim 29, wherein the profile information includes one or more of a class of service information, a denial of service information, and a preferred language information.

34. The system of claim 29, wherein the data store is integrated with the communications system, the message control system, or the interactive notification application.

35. The system of claim 28, wherein the message control system and the interactive notification application are integrated.

36. The system of claim 28, wherein the communications system is at least one of a voice mail system, an e-mail system, a facsimile system, and a caller identification system.

37. The system of claim 28, wherein the triggering event is at least one of a missed call, a received voice mail message, a received e-mail message, and a received fax.

38. The system of claim 28, wherein the message control system uses a store-and-forward technique.

39. The system of claim 28, wherein the message control system routes messages to the subscriber over at least one of a wireless communications network and a wired communications network.

40. The system of claim 28, wherein the message control system routes the messages to at least one of a telephone handset, a personal digital assistant, and a computer.

41. The system of claim 28, wherein the interactive notification application retrieves the additional data from at least one of a network, the Internet, and a database.

42. The system of claim 30, wherein the interactive notification application retrieves the additional data by performing a search using a search query, said search query being derived from the profile information.

43. The system of claim 28, wherein the interactive notification application converts the additional data to a format compatible with the notification message and the interactive notification message.

44. The system of claim 28, wherein the additional data is inserted before pre-existing data of the notification message.

45. The system of claim 28, wherein the additional data includes at least one of text data, multimedia data, embedded links, menu-driven prompts, and WML extensions.

46. The system of claim 28, wherein when the subscriber responds to the interactive notification message, a reply message is routed by the message control system to a service application, and a two-way messaging session is established between the subscriber and the service application.

47. The system of claim 46, wherein the two-way messaging session allows the subscriber to retrieve subsequent data.

48. The system of claim 46, wherein a predetermined period of inactivity by both the service application and the subscriber causes the interactive notification application to terminate the two-way messaging session.

49. The system of claim 46, wherein the subscriber responds to the interactive notification message by manipulating a menu, said menu being generated based on the interactive notification message and being displayed on a device associated with the subscriber.

50. The system of claim 46, wherein the interactive notification application includes a memory for storing a history of the two-way messaging session.

51. The system of claim 47, wherein the interactive notification application refreshes the subsequent data before sending the subsequent data to the subscriber.

52. The system of claim 28, wherein the notification message and the interactive notification message are SMS messages.

53. The system of claim 28, wherein the notification message and the interactive notification message are WAP messages.

54. The system of claim 28, wherein the message control system is an SMSC.

55. A system for alerting a subscriber comprising:
a detection means for detecting a triggering event;
a message means for generating a notification message corresponding to the triggering event;
a delivery means for routing messages;
a search means for retrieving additional data; and
a join means for adding the additional data to the notification message to form an interactive notification message,
wherein the delivery means routes the interactive notification message to the subscriber.

56. The system of claim 27, further comprising a storage means for storing information defining a profile of the subscriber.

57. The system of claim 28, wherein the search means uses the profile of the subscriber to retrieve the additional data.

58. A system for allowing an operator to develop and test additional data, said additional data for appending to a notification message, comprising:
software instructions for enabling a computer to perform predetermined operations, and a computer readable medium bearing the software instructions;
wherein the predetermined operations include:
receiving the additional data input by the operator;
generating a message from the additional data;
storing the message; and
testing the stored message.

59. The system of claim 58, further comprising:
counting a number of characters input by the operator; and
indicating whether the counted number of characters exceeds a predetermined maximum number of characters for the message.

60. The system of claim 58, wherein testing the stored message includes displaying the message.

61. The system of claim 58, wherein testing the stored message includes verifying the operability of one or more links embedded in the message.
